(19) United States
(12) Patent Application Publication
(10) Pub. No.: US 2023/0239670 A1
(43) Pub. Date: Jul. 27, 2023

(54) DISASTER INFORMATION NOTIFICATION DEVICE, DISASTER INFORMATION NOTIFICATION METHOD, AND STORAGE MEDIUM

(71) Applicant: TOYOTA JIDOSHA KABUSHIKI KAISHA, Aichi-ken (JP)

(72) Inventors: Takeo MORIAI, Nagakute-shi (JP); Masakazu SETOYAMA, Miyoshi-shi (JP); Teruo MORI, Ichinomiya-shi (JP); Takanobu HIRAKOSHI, Nagoya-shi (JP)

(21) Appl. No.: 17/986,893

(22) Filed: Nov. 15, 2022

(30) Foreign Application Priority Data
Jan. 21, 2022 (JP) 2022-008135

(51) Int. Cl. H04W 4/90; H04W 4/40

(52) U.S. Cl. CPC H04W 4/90; H04W 4/40

(57) ABSTRACT

A disaster information notification device has a processor. The processor acquires disaster information from at least either a server or sensors installed in a vehicle, and, upon acquiring disaster information, activates a predetermined on-board device installed in the vehicle so as to communicate the disaster information to a surrounding area.

### CROSS REFERENCE TO RELATED APPLICATION

This application claims priority to Japanese Patent Application No. 2022-008135 filed on Jan. 21, 2022, incorporated herein by reference in its entirety.

### BACKGROUND

### 1. Technical Field

The present disclosure relates to a disaster information notification device, a disaster information notification method, and a storage medium.

### 2. Description of Related Art

Japanese Unexamined Patent Application Publication No. 2007-206658 (JP 2007-206658 A) discloses a vehicle equipped with an electric display screen as an exterior indicator lamp. In the vehicle of JP 2007-206658 A, a driver can switch the display of the exterior indicator lamp to a message calling for help by pressing an emergency button.

### SUMMARY

However, the device described in JP 2007-206658 A can be applied to only those vehicles that are equipped with an exterior indicator lamp, and thus leaves room for improvement in terms of widely notifying disaster information.

An object of the present disclosure is to provide a disaster information notification device, a disaster information notification method, and a storage medium that can widely notify disaster information.

A disaster information notification device according to claim 1 has a processor. The processor acquires disaster information from at least either a server or sensors installed in a vehicle, and, upon acquiring disaster information, activates a predetermined on-board device installed in the vehicle so as to communicate the disaster information to a surrounding area.

The disaster information notification device according to claim 1 acquires disaster information from at least either the server or the sensors installed in the vehicle. Upon acquiring disaster information, the disaster information notification device activates a predetermined on-board device installed in the vehicle so as to communicate the disaster information to the surrounding area. Since disaster information is thus communicated by activating the on-board device that is originally installed in the vehicle, there is no need for a dedicated notification device or the like and disaster information can be notified from many vehicles. The “disaster information” here is a concept that is not limited to information on a large-scale disaster such as an earthquake, tsunami, flood, landslide, or fire but also includes information on bad weather such as a strong wind, thunder, snowstorm, or heavy rain.

The disaster information notification device according to claim 2 is the disaster information notification device of claim 1, wherein the processor activates the on-board device in an activation pattern different from that at normal times.

By activating the on-board device in a pattern different from that at normal times, the disaster information notification device according to claim 2 can effectively call the attention of people around the vehicle.

The disaster information notification device according to claim 3 is the disaster information notification device of claim 2, wherein the processor changes the activation pattern of the on-board device according to a degree of importance of the acquired disaster information.

For example, by making the amount of sound or the amount of light larger when the degree of importance of disaster information is higher, the disaster information notification device according to claim 3 allows people around the vehicle to intuitively grasp the degree of importance of the disaster information.

The disaster information notification device according to claim 4 is the disaster information notification device of claim 1, wherein when a degree of importance of the acquired disaster information is low, the processor activates the on-board devices of only stationary vehicles in a predetermined notification area in which disaster information is to be notified, and when the degree of importance of the acquired disaster information is high, the processor activates the on-board devices of stationary vehicles and traveling vehicles in the notification area.

When the degree of importance of disaster information is low, the disaster information notification device according to claim 4 activates the on-board devices of only stationary vehicles to thereby avoid obstructing the travel of vehicles. Further, when the degree of importance of disaster information is high, the disaster information notification device activates the on-board devices of traveling vehicles in addition to those of stationary vehicles to thereby call the attention of more people.

The disaster information notification device according to claim 5 is the disaster information notification device of claim 1, wherein the processor communicates disaster information to a surrounding area by activating at least one of headlamps, turn signal lamps, brake lamps, a horn, and wipers installed in the vehicle.

For example, by lighting or flashing the headlamps, the turn signal lamps, and the brake lamps at a predetermined timing and a predetermined amount of light, the disaster information notification device according to claim 5 can effectively communicate disaster information to the surrounding area even at night. Or, for example, by honking the horn at a predetermined timing and a predetermined amount of sound, this device can communicate disaster information to the surrounding area by sound. Further, for example, by moving the front windshield wipers and the rear windshield wipers at a predetermined speed, this device communicates disaster information to the surrounding area.

The disaster information notification device according to claim 6 is the disaster information notification device of claim 1, wherein the processor releases door locks of stationary vehicles in a predetermined notification area in which disaster information is to be notified.

The disaster information notification device according to claim 6 releases the door locks of stationary vehicles, so that people around those vehicles can temporarily take refuge in the vehicles.

A disaster information notification method according to claim 7 acquires disaster information from at least either a server or sensors installed in a vehicle, and, upon acquiring disaster information, activates a predetermined on-board device installed in the vehicle so as to communicate the disaster information to a surrounding area.

A storage medium according to claim 8 stores a program that makes a computer execute a process of acquiring disaster information from at least either a server or sensors installed in a vehicle, and, upon acquiring disaster information, activating a predetermined on-board device installed in the vehicle so as to communicate the disaster information to a surrounding area.

As has been described above, the disaster information notification device, the disaster information notification method, and the storage medium according to the present disclosure can widely notify disaster information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing the overall configuration of a system according to an embodiment;

FIG. 2 is a block diagram showing the hardware configuration of a disaster information notification device according to the embodiment;

FIG. 3 is a block diagram showing the hardware configuration of a vehicle according to the embodiment;

FIG. 4 is a block diagram showing the functional configuration of the disaster information notification device according to the embodiment; and

FIG. 5 is a flowchart showing one example of the flow of a disaster information notification process in the embodiment.

### DETAILED DESCRIPTION OF EMBODIMENTS

A system S including a disaster information notification device 10 according to an embodiment will be described with reference to the drawings.

### Overall Configuration

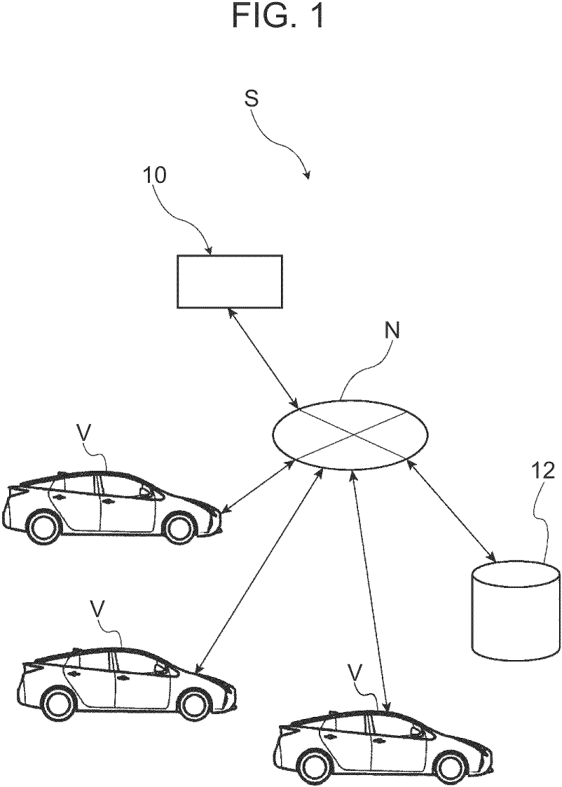

As shown in FIG. 1, the system S includes the disaster information notification device 10, a server 12, and a plurality of vehicles V in its configuration. The disaster information notification device 10, the server 12, and the plurality of vehicles V can communicate with one another through a network N. While three vehicles V are shown as one example in FIG. 1, the present disclosure is not limited to this example and the system S may include four or more vehicles V in its configuration. Or the system S may include one or two vehicles V in its configuration.

The server 12 accumulates pieces of disaster information from locations. The disaster information notification device 10 is configured to be able to acquire disaster information from the server 12 through the network N.

Each of the plurality of vehicles V sends predetermined vehicle information to the disaster information notification device 10 through the network N. The disaster information notification device 10 is configured to be able to control some on-board devices installed in the vehicles V through the network N.

The system S is configured as has been described above. Upon acquiring disaster information, the disaster information notification device 10 according to this embodiment activates predetermined on-board devices installed in the vehicles V so as to communicate the disaster information to the surrounding area.

### Hardware Configuration of Disaster Information Notification Device 10

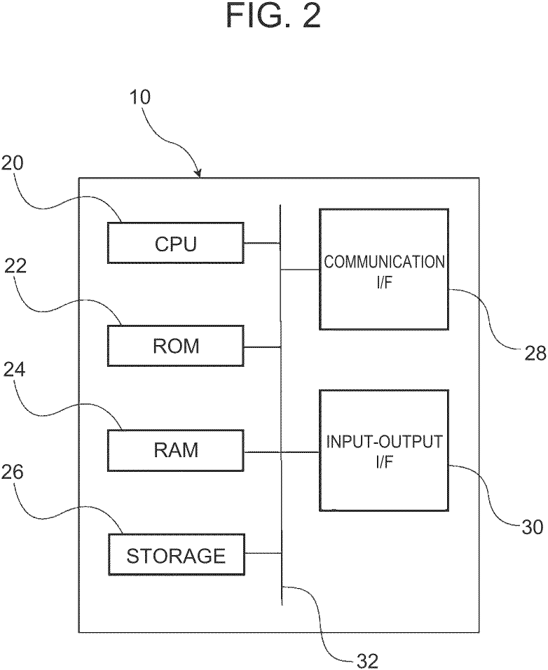

FIG. 2 is a block diagram showing the hardware configuration of the disaster information notification device 10. As shown in FIG. 2, the disaster information notification device 10 includes, in its configuration, a central processing unit (CPU; processor) 20, a read-only memory (ROM) 22, a random-access memory (RAM) 24, a storage 26, a communication interface (communication I/F) 28, and an input-output interface (input-output I/F) 30. These components are communicably connected to one another through a bus 32.

The CPU 20 is a central arithmetic processing unit and executes various programs and control parts. Specifically, the CPU 20 reads a program from the ROM 22 or the storage 26 and executes the program using the RAM 24 as a work area. Further, the CPU 20 controls the aforementioned components and performs various arithmetic processes in accordance with programs recorded in the ROM 22 or the storage 26.

The ROM 22 stores various programs and various pieces of data. The RAM 24 is a non-transitory recording medium (storage medium) that temporarily stores a program or data as a work area. The storage 26 is a non-transitory recording medium (storage medium) that is formed by a hard disk drive (HDD) or a solid-state drive (SSD) and stores various programs including an operating system and various pieces of data. In this embodiment, the storage 26 stores a vehicle control program, various pieces of data, etc. for performing a disaster information notification process.

The communication I/F 28 is an interface for the disaster information notification device 10 to communicate with the server 12 and other devices, and uses a standard, for example, a controller area network (CAN), Ethernet (R), Long Term Evolution (LTE), Fiber Distributed Data Interface (FDDI), or Wi-Fi (R).

The input-output I/F 30 is an interface for input and output between the disaster information notification device 10 and devices in the surrounding area.

### Hardware Configuration of Vehicle V

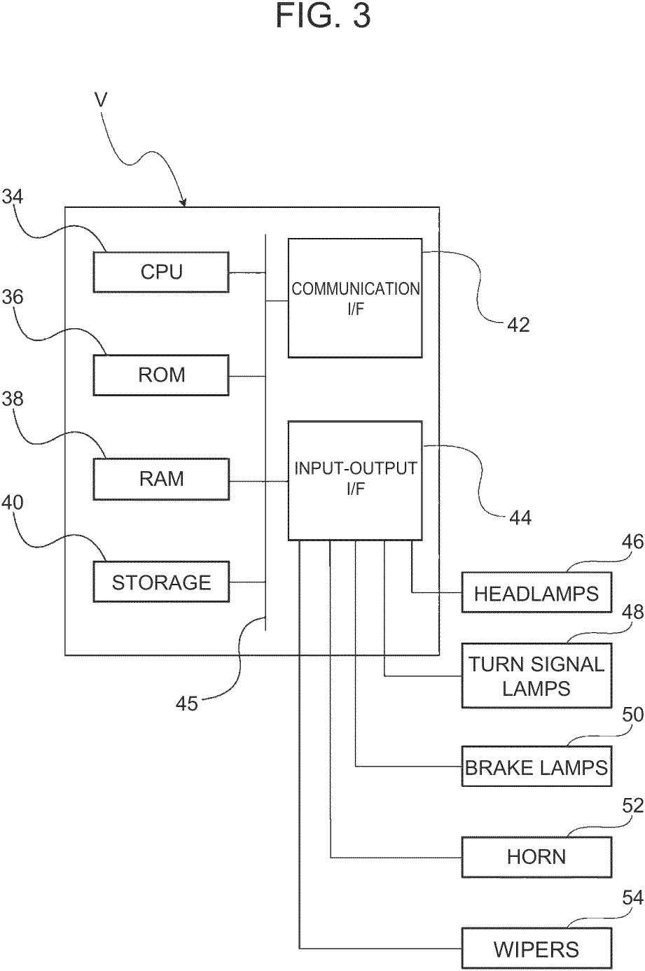

FIG. 3 is a block diagram showing the hardware configuration of the vehicle V. As shown in FIG. 3, the vehicle V includes, in its configuration, a central processing unit (CPU; processor) 34, a read-only memory (ROM) 36, a random-access memory (RAM) 38, a storage 40, a communication interface (communication I/F) 42, and an input-output interface (input-output I/F) 44. These components are communicably connected to one another through a bus 45.

The CPU 34 is a central arithmetic processing unit and executes various programs and control parts. Specifically, the CPU 34 reads a program from the ROM 36 or the storage 40 and executes the program using the RAM 38 as a work area. The CPU 34 controls the aforementioned components and performs various arithmetic processes in accordance with programs recorded in the ROM 36 or the storage 40.

The ROM 36 stores various programs and various pieces of data. The RAM 38 is a non-transitory recording medium (storage medium) that temporarily stores a program or data as a work area. The storage 40 is a non-transitory recording medium (storage medium) that is formed by a hard disk drive (HDD) or a solid-state drive (SSD) and stores various programs including an operating system and various pieces of data.

The communication I/F 42 is an interface for the vehicle V to communicate with the disaster information notification device 10 etc., and uses a standard, for example, a controller area network (CAN), Ethernet (R), Long Term Evolution (LTE), Fiber Distributed Data Interface (FDDI), or Wi-Fi (R).

Here, headlamps 46, turn signal lamps 48, brake lamps 50, a horn 52, and wipers 54 are electrically connected to the input-output I/F 44.

The headlamps 46 are on-board devices that are provided at left and right ends of a front part of the vehicle V and light up as an occupant operates a predetermined button provided in a driver’s seat. The headlamps 46 are configured to be switchable between high beam and low beam.

The turn signal lamps 48 are on-board devices that are provided at left and right ends of a front part of the vehicle V and at left and right ends of a rear part of the vehicle V, and flash as an occupant operates a predetermined button provided near the driver’s seat. The left and right turn signal lamps 48 flash at the same time when an occupant presses a hazard lamp switch.

The brake lamps 50 are on-board devices that are provided at a plurality of locations including left and right ends of a rear part of the vehicle V and light up as an occupant operates a brake pedal.

The horn 52 is an on-board device that generates sound to an outside of the vehicle V as an occupant presses a predetermined portion provided near the driver’s seat. The wipers 54 are on-board devices that include front windshield wipers provided at a vehicle front part and rear windshield wipers provided at a vehicle rear part, and are activated as an occupant operates a predetermined button provided near the driver’s seat. When activated, the front windshield wipers remove water droplets, dust, etc. on a front windshield by moving along the front windshield. When activated, the rear windshield wipers remove water droplets, dust, etc. on a rear windshield by moving along the rear windshield.

### Functional Configuration of Disaster Information Notification Device 10

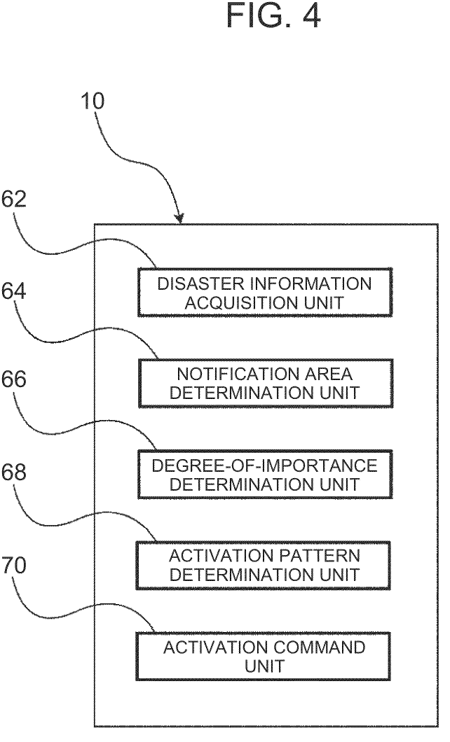

The disaster information notification device 10 realizes various functions using the hardware resources shown in FIG. 3. The functional configuration realized by the disaster information notification device 10 will be described with reference to FIG. 4.

As shown in FIG. 4, the disaster information notification device 10 includes, as functional components, a disaster information acquisition unit 62, a notification area determination unit 64, a degree-of-importance determination unit 66, an activation pattern determination unit 68, and an activation command unit 70 in its configuration. These functional components are realized as the CPU 20 reads and executes programs stored in the ROM 22 or the storage 26.

The disaster information acquisition unit 62 acquires disaster information from at least either the server 12 or sensors (not shown) installed in the vehicles V. Specifically, the disaster information acquisition unit 62 acquires disaster information by periodically accessing the server 12. Further, the disaster information acquisition unit 62 is configured to be able to receive signals from the sensors installed in the vehicles V. Examples of the sensors installed in the vehicles V include a sensor that detects submergence and a rain sensor that detects an amount of rainfall.

The notification area determination unit 64 determines an area where notification is to be made based on the disaster information acquired by the disaster information acquisition unit 62. For example, when disaster information on an earthquake is acquired by the disaster information acquisition unit 62, the notification area determination unit 64 determines, as the notification area, an area where a seismic intensity equal to or higher than a predetermined seismic intensity has been registered. For example, when disaster information on a tsunami is acquired by the disaster information acquisition unit 62, the notification area determination unit 64 determines, as the notification area, a coastal area where damage from the tsunami can be expected.

The degree-of-importance determination unit 66 determines the degree of importance of the disaster information acquired by the disaster information acquisition unit 62. For example, when disaster information on an earthquake is acquired by the disaster information acquisition unit 62, the degree-of-importance determination unit 66 determines the degree of importance of the disaster information such that the degree of importance is higher in a region where the seismic intensity of the earthquake is higher. For example, when disaster information on heavy rain is acquired by the disaster information acquisition unit 62, the degree-of-importance determination unit 66 determines the degree of importance such that the degree of importance is higher in a region where the amount of precipitation is larger. In the case where only two types, low and high, of the degree of importance of disaster information are set, the degree-of-importance determination unit 66 determines which of the degrees of importance applies. In the case where the degree of importance of disaster information is set on a scale of three or more levels, the degree-of-importance determination unit 66 determines the level of the degree of importance corresponding to the disaster information. In the following description, the case where only two types, low and high, of the degree of importance are set will be described as one example.

The activation pattern determination unit 68 determines the activation pattern of the on-board devices according to the degree of importance of disaster information determined by the degree-of-importance determination unit 66. Specifically, the activation pattern determination unit 68 changes the activation pattern of the on-board devices according to the degree of importance of the acquired disaster information. For example, when the degree of importance of the disaster information is low, the activation pattern determination unit 68 determines, as devices to be activated, those on-board devices that notify to the surrounding area by emitting light, such as the headlamps 46, the turn signal lamps 48, and the brake lamps 50. When the degree of importance of the disaster information is high, the activation pattern determination unit 68 determines, as devices to be activated, those on-board devices that generate sound, such as the horn 52, in addition to the on-board devices that emit light, such as the headlamps 46, the turn signal lamps 48, and the brake lamps 50. Further, the activation pattern determination unit 68 may determine, as devices to be activated, those on-board devices that call the attention of people in the surrounding area by movement, such as the wipers 54, according to the degree of importance of the disaster information.

As one example, the activation pattern determination unit 68 of this embodiment activates the on-board devices in an activation pattern different from an activation pattern in which the on-board devices are activated during normal travel of the vehicles V. For example, the turn signal lamps 48 are configured such that, during normal travel of the vehicle V, one of the left and right turn signal lamps 48 flashes as an occupant performs operation when turning left or right. When an occupant presses the hazard lamp switch, the left and right turn signal lamps 48 flash at the same timing. By contrast, when activating the turn signal lamps 48, the activation pattern determination unit 68 may activate them, for example, in an activation pattern in which the left and right turn signal lamps 48 flash alternately.

The activation command unit 70 gives a command to activate the on-board devices to the vehicles V through the network N. Specifically, the activation command unit 70 gives a command to activate the on-board devices to vehicles V that can communicate through the network N within the notification area determined by the notification area determination unit 64. As the activation command unit 70 activates the on-board devices installed in the vehicles V, disaster information is communicated to people in the surrounding area.

Here, in this embodiment, as one example, the activation command unit 70 changes activation target vehicles of which the on-board devices are to be activated, according to the degree of importance determined by the degree-of-importance determination unit 66. Specifically, when the degree of importance of disaster information is low, the activation command unit 70 sets, as activation target vehicles, only stationary vehicles within the notification area. Therefore, when the degree of importance of disaster information is low, the on-board devices of vehicles V traveling in the notification area are not activated. On the other hand, when the degree of importance of disaster information is high, the activation command unit 70 sets, as activation target vehicles, both stationary vehicles and traveling vehicles within the notification area. Thus, when the degree of importance of disaster information is high, the on-board devices of all vehicles that can communicate with the disaster information notification device 10 through the network within the notification area are activated.

Further, the activation command unit 70 gives a command to activate the on-board devices of the vehicles V in the activation pattern determined by the activation pattern determination unit 68. Thus, all the activation target vehicles within the notification area activate the on-board devices in the same activation pattern.

Further, in this embodiment, as one example, when the degree of importance of disaster information is high, the activation command unit 70 gives a command to release door locks of stationary vehicles in addition to a command to activate the on-board devices. Specifically, the activation command unit 70 gives a command to release the door locks of stationary vehicles within the notification area, regardless of whether they are being used, to allow people around the vehicles V to freely get into the vehicles V. In the case where the owner of the vehicle V has made settings beforehand to prohibit the door lock from being released, the door lock is not released by the activation command unit 70. The activation command unit 70 only releases door lock, and starting the vehicle V requires a dedicated key. Further, the activation command unit 70 may release door lock for only a predetermined time. In this case, when a predetermined time has elapsed, the activation command unit 70 may make an announcement through an in-vehicle speaker etc., asking those taking refuge in the vehicle cabin to get out of the vehicle V.

### Workings

Next, the workings of this embodiment will be described.

### Disaster Information Notification Process

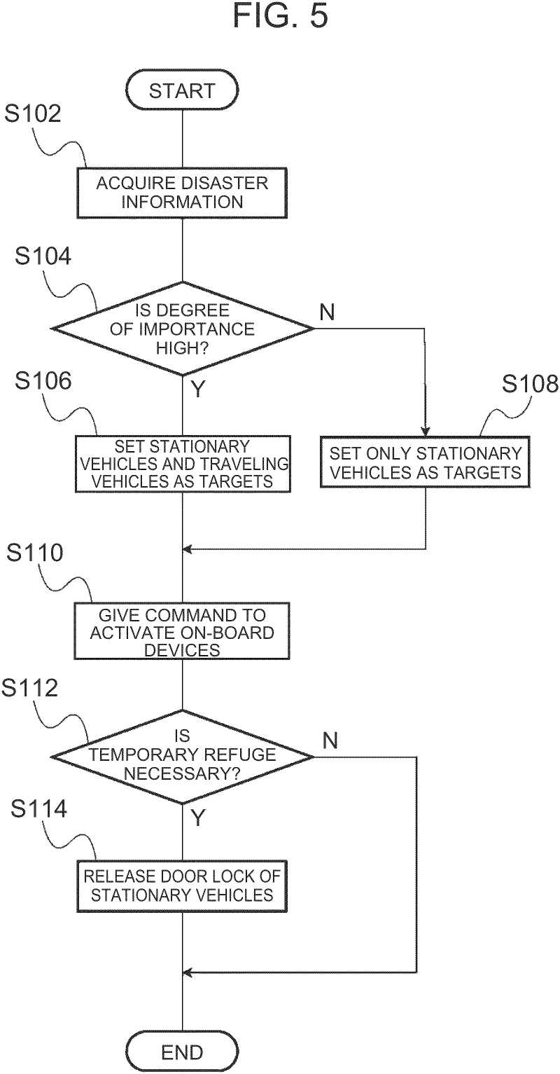

FIG. 5 is a flowchart showing one example of the flow of the disaster information notification process by the disaster information notification device 10 according to this embodiment. This disaster information notification process is executed as the CPU 20 reads a program from the storage 26 and decompresses it in the RAM 24.

In step S102, the CPU 20 acquires disaster information. Specifically, the CPU 20 acquires disaster information from at least either the server 12 or sensors installed in the vehicles V by the function of the disaster information acquisition unit 62.

In step S104, the CPU 20 determines whether the degree of importance of the disaster information is high. In this embodiment, as one example, the degree of importance is set to be either low or high by the function of the degree-of-importance determination unit 66. When it is determined by the degree-of-importance determination unit 66 that the degree of importance of the disaster information is high, the CPU 20 moves to processing of step S106. When it is determined by the degree-of-importance determination unit 66 that the degree of importance of the disaster information is low, the CPU 20 moves to processing of step S108.

In step S106, the CPU 20 sets both stationary vehicles and traveling vehicles as vehicles of which the on-board devices are to be activated, and moves to processing of step S110. On the other hand, in step S108, the CPU 20 sets only stationary vehicles as vehicles of which the on-board devices are to be activated, and moves to processing of step S110.

In step S110, the CPU 20 gives a command to activate the on-board devices. Specifically, the CPU 20 gives a command to activate the predetermined on-board devices to the activation target vehicles within the notification area by the function of the activation command unit 70. In this case, the on-board devices to be activated and the activation pattern are determined beforehand by the activation pattern determination unit 68.

In step S112, it is determined whether temporary refuge is necessary. Specifically, it is determined that temporary refuge is necessary, when the degree of importance of the disaster information is high and quickly taking refuge is necessary. For example, disaster information that necessitates temporary refuge may be stored beforehand in a storage area of the disaster information notification device 10, and it may be determined that temporary refuge is necessary when the acquired disaster information matches stored disaster information. Examples of disaster information that necessitates temporary refuge include a thunder.

When it is determined in step S112 that temporary refuge is necessary, the CPU 20 moves to processing of step S114 and releases the door locks of stationary vehicles. Specifically, the CPU 20 gives a command to release the door lock to the stationary vehicles within the notification area by the function of the activation command unit 70. Then, the CPU 20 ends the disaster information notification process. On the other hand, when it is determined in step S112 that temporary refuge is not necessary (unnecessary), the CPU 20 ends the disaster information notification process without executing processing of step S114.

As has been described above, upon acquiring disaster information, the disaster information notification device 10 according to this embodiment activates the predetermined on-bard devices installed in the vehicles V so as to communicate the disaster information to the surrounding area. Since the disaster information is thus communicated by activating the on-board devices that are originally installed in the vehicles V, there is no need for a dedicated notification device or the like and disaster information can be notified from many vehicles.

In particular, in this embodiment, disaster information can be effectively communicated to the surrounding area even at night by lighting or flashing the headlamps 46, the turn signal lamps 48, and the brake lamps 50 at a predetermined timing and a predetermined amount of light.

In addition, in this embodiment, disaster information can be communicated to the surrounding area by sound by honking the horn 52 at a predetermined timing and a predetermined amount of sound. Further, in this embodiment, the attention of people in the surrounding area can be called by moving the wipers 54 of the plurality of vehicles V at a predetermined speed.

Further, in this embodiment, the attention of people around the vehicles V can be effectively called by activating the on-board devices in a pattern different from that at normal times.

Moreover, in this embodiment, the activation pattern of the on-board devices is changed according to the degree of importance of disaster information. Specifically, the amount of sound, the amount of light, etc. of the on-board devices are made larger as the degree of importance becomes higher, so that people around the vehicles V can intuitively grasp the degree of importance of the disaster information.

In this embodiment, when the degree of importance of disaster information is low, only the on-board devices of stationary vehicles are activated to avoid obstructing the travel of traveling vehicles V. When the degree of importance of disaster information is high, the on-board devices of traveling vehicles V in addition to those of stationary vehicles are activated to call the attention of more people.

Further, in this embodiment, the door locks of stationary vehicles are released under predetermined conditions, so that people around the vehicles V can temporarily take refuge in these vehicles.

While the disaster information notification device 10 according to the embodiment and modified examples has been described above, it should be understood that the present disclosure can be implemented in various forms within the scope of the gist of the disclosure. For example, in the above embodiment, the configuration in which the disaster information notification device 10 is provided outside the vehicles V has been described. However, the present disclosure is not limited to this example, and the disaster information notification device 10 may be provided in the vehicle V.

In the following, one example of the case where the disaster information notification device 10 is provided in the vehicle V will be described. When disaster information on submergence etc. is acquired by sensors installed in the vehicle V, the disaster information notification device 10 activates predetermined on-board devices so as to communicate the disaster information to the surrounding area. Further, the disaster information notification device 10 sends the disaster information to vehicles V in the surrounding area using inter-vehicle communication or the like.

Vehicles V traveling around the submerged vehicle V acquire the disaster information by inter-vehicle communication or the like and activate predetermined on-board devices so as to communicate the disaster information to the surrounding area. The disaster information is further sent to vehicles V in the surrounding area using inter-vehicle communication or the like. In this way, in the event of a flood or the like, disaster information can be sent to an area that is not submerged, and thus the risk of submergence can be notified.

In the above embodiment, the disaster information notification device 10 activates the on-board devices in an activation pattern different from an activation pattern in which the on-board devices are activated during normal travel of the vehicles V. However the present disclosure is not limited to this example. The on-board devices may be activated in the activation pattern in which they are activated during normal travel of the vehicles V. Also in this case, for example, if unattended stationary vehicles light up the headlamps 46 all at the same time, this can notify people in the surrounding area of a dangerous situation. Further, if a plurality of vehicles V traveling in sunny weather activates wipers at the same time, this can notify people in the surrounding area of a dangerous situation.

Further, in the above embodiment, the configuration in which the ordinary headlamps 46 are activated has been described. However, the preset disclosure is not limited to this example. For example, in the case of a vehicle V in which light emitting diodes (LEDs) that can draw characters, figures, etc. on a road surface are installed as headlamps, drawing disaster information on a road surface can effectively notify it to people in the surrounding area.

Moreover, the process that the CPU 20 executes by reading a program in the above embodiment may be executed by various processors other than the CPU 20. Examples of processors in this case include a programmable logic device (PLD), such as a field-programmable gate array (FPGA), of which the circuit configuration can be changed after manufacturing, and a dedicated electric circuit, such as an application-specific integrated circuit (ASIC), that is a processor having a circuit configuration specially designed to execute a specific process. Each process may be executed by one of these various processors, or may be executed by a combination of two or more processors of the same type or different types. For example, the process may be executed by a combination of a plurality of FPGAs or a combination of a CPU and an FPGA. The hardware structure of these various processors is more specifically an electric circuit combining circuit elements, including semiconductor devices.

In the above embodiment, the programs have been described as in the form of being stored (installed) beforehand in non-transitory recording media (storage media) that can be read by a computer. However, the present disclosure is not limited to this example. The programs may be provided in the form of being recorded in non-transitory recording media (storage media), such as a compact disc read-only memory (CD-ROM), a digital versatile disc read-only memory (DVD-ROM), or a universal serial bus (USB). Or the programs may be in the form of being downloaded from an external device through a network.

In addition, the flow of the process described in the above embodiment is one example; within the scope of the objective, unnecessary steps may be omitted, new steps may be added, or the order of processing may be rearranged.

What is claimed is:

1. A disaster information notification device comprising a processor, the processor acquiring disaster information from at least either a server or sensors installed in a vehicle, and, upon acquiring disaster information, activating a predetermined on-board device installed in the vehicle so as to communicate the disaster information to a surrounding area.

2. The disaster information notification device according to claim 1, wherein the processor activates the on-board device in an activation pattern different from that at normal times.

3. The disaster information notification device according to claim 2, wherein the processor changes the activation pattern of the on-board device according to a degree of importance of the acquired disaster information.

4. The disaster information notification device according to claim 1, wherein, when a degree of importance of the acquired disaster information is low, the processor activates the on-board devices of only stationary vehicles in a predetermined notification area in which disaster information is to be notified, and when the degree of importance of the acquired disaster information is high, the processor activates the on-board devices of stationary vehicles and traveling vehicles in the notification area.

5. The disaster information notification device according to claim 1, wherein the processor communicates disaster information to a surrounding area by activating at least one of headlamps, turn signal lamps, brake lamps, a horn, and wipers installed in the vehicle.

6. The disaster information notification device according to claim 1, wherein the processor releases door locks of stationary vehicles in a predetermined notification area in which disaster information is to be notified.

7. A disaster information notification method that acquires disaster information from at least either a server or sensors installed in a vehicle, and, upon acquiring disaster information, activating a predetermined on-board device installed in the vehicle so as to communicate the disaster information to a surrounding area.

8. A non-transitory storage medium storing a program that makes a computer execute a process of acquiring disaster information from at least either a server or sensors installed in a vehicle, and, upon acquiring disaster information, activating a predetermined on-board device installed in the vehicle so as to communicate the disaster information to a surrounding area.
